(19) United States
(12) Patent Application Publication
(10) Pub. No.: US 2005/0198584 A1
(43) Pub. Date: Sep. 8, 2005

(54) System and method for controlling manipulation of tiles within a sidebar

(76) Inventors: David A. Matthews, Seattle, WA (US); Charles Cummins, Seattle, WA (US); Fabrice A. Debry, Bellevue, WA (US); Justin Mann, Redmond, WA (US); Hillel Noah Cooperman, Sammamish, WA (US); Timothy P. McKee, Seattle, WA (US)

Correspondence Address: SHOOK, HARDY & BACON L.L.P., 2555 GRAND BOULEVARD, KANSAS CITY, MO, 64108-2613, US

(21) Appl. No.: 10/764,500

(22) Filed: Jan. 27, 2004

(51) Int. Cl. G06F 3/00

(52) U.S. Cl. 715/779; 715/769

(57) ABSTRACT

The present invention is directed to a method and system for allowing a user to control the user interface environment and specifically a sidebar within the user interface environment. The method controls tiles within a sidebar to respond to a manipulation request by a system user or by an application to manipulate a selected tile. The method includes determining a current status of the selected tile and selecting an appropriate rule for manipulating the tile based on the status of the tile and an identity of the manipulation requestor. One rule set is provided for the application and another rule set is provided for the user. The method further includes manipulating the selected tile in accordance with the appropriate rule. The user rules allow insertion of the tile in most, if not all cases, whereas the application rules may prohibit insertion of the selected tile.

### CROSS-REFERENCE TO RELATED APPLICATIONS

None

### STATEMENT REGARDING FEDERALLY SPONSORED RESEARCH OR DEVELOPMENT

None.

### TECHNICAL FIELD

Embodiments of the present invention relate to computing environments. More particularly, embodiments of the invention are directed to a system and method for allowing a user to control access to and presentation of available information within a computing environment.

### BACKGROUND OF THE INVENTION

In today's information saturated environments, such as the Internet, a local or remote computer network, or any combination of the Internet and such networks, it is often difficult for a user to track the potentially large quantities and varieties of interesting communications and information. Such communications and information include, for example, email, instant messaging, file transfers, local weather, appointments, schedules, personal contacts, statistical information, file status, stock quotes, sports scores, local traffic, or any other type of communications or information.

In a platform such as Microsoft Windows™ produced by the Microsoft Corporation of Redmond, Washington, numerous applications related to the types of information and communications set forth above simultaneously compete for a user's attention. Applications compete for limited space within the user interface to make themselves visible at all times. Often, the effect of applications competing for a user's attention is detrimental to the user as the user cannot quickly and easily access the information most relevant to the user.

In order to assist a user in keeping track of information and communications, several conventional schemes have been developed. Such schemes are typically limited by what types of communications or information can be tracked or displayed, by the manner in which the communications and information are accessed or otherwise provided to the user, or by the inability to facilitate sharing of the communications or information between users. Further, conventional schemes that have attempted to address these problems tend to be limited by an inability to provide a single interface that allows for concurrent information retrieval, display or access in combination with communications and communication access points in a dynamic integrated environment. Consequently, users are often left with cluttered displays, which fail to provide both communications and information access and interaction in an integrated environment.

Several conventional messaging type schemes have attempted to address these problems. However, such schemes typically provide large windows that take up substantial amounts of screen space. Further, such schemes tend to separate the communications capabilities from the information capabilities via one or more tabs or the like. Consequently, particular information cannot be easily shared or communicated from within the applications provided by these schemes. Further, such schemes become unwieldy as the amount of information tracked by a user increases, and as the number of communications contacts maintained by the user increases. In particular, as the amount of information increases, the user is forced to scroll through large amounts of data or communications channels.

At least one conventional scheme has attempted to address some of the aforementioned problems. This scheme provides an application that allows a user to customize at least one icon in a scrollable strip along one edge of a computer display device. This scheme provides iconized links to particular information sources and uses conventional techniques to populate each customized icon with information retrieved from the information sources. However, this scheme fails to provide the level of communications capabilities offered by messaging schemes. Further, this scheme does not provide for nesting or otherwise organizing groups of icons in order to aggregate multiple icons. In addition, the icons of this scheme are not easily transportable and no real mechanism exists for transferring icons between users.

A related scheme allows a user to customize a scrolling ticker type display window to provide continuously updated scrolling information from a predefined set of available information. However, the set of information that is available to this scheme is predefined and users are provided with limited control over information options. Another limitation is that users are not able to add or edit information sources, such as by modifying the icons as described above.

Still other schemes for providing custom information views or displays involve a technique known as “web scraping.” In general, such schemes allow a user to specify particular portions of unique Internet Web pages, i.e., source web pages, to be displayed on a single customized web page. These schemes do not provide for communications capability and require views to be opened in a window that occupies a substantial portion of a display device.

A new scheme is needed for automatically providing dynamic communication access and information awareness in an interactive peripheral display without requiring a user to tab between communications channels or information types. Further, such a scheme should not require a user to choose from a predefined list of communication access points and information categories or sources, but instead should allow for customization of communications access points and information sources.

Accordingly, a scheme is needed that provides a user of a platform such as Microsoft Windows with the ability to control visible information so that the user always has unobstructed access to information that the user considers to be important. A system is needed that provides applications with incentive to allow a user to decide which information should remain visible.

### BRIEF SUMMARY OF THE INVENTION

Embodiments of the present invention are directed to a method and system for use in a computing environment to present and provide user access to information.

In one aspect, the present invention is directed to a method for controlling tiles within a sidebar in response to a manipulation request by a system user or by an application to manipulate a selected tile. The method includes determining a current status of the selected tile and selecting an appropriate rule set based on the identity of the manipulation requestor, wherein the appropriate rule set is one of an application manipulation rule set and a user manipulation rule set. The method additionally includes locating an appropriate rule within the appropriate rule set based on the current status of the selected tile and request content and manipulating the tile in accordance the appropriate rule.

In an additional aspect, the present invention is directed to a system for controlling tiles within a sidebar when a manipulation request is made by a system user or by an application to manipulate a selected tile. The system includes a status determination module for indicating a current status of the selected tile. The system additionally includes user manipulation rules for determining an appropriate disposition of the selected tile based on the current status of the selected tile when the manipulation request originates from the system user and application manipulation rules for determining disposition of the selected tile based on the current status of the selected tile when the manipulation request originates from the application. The system additionally includes manipulation tools for manipulating the selected tile in accordance with one of the user manipulation rules and the application manipulation rules.

In yet a further aspect, the invention includes a method for controlling a selected tile within a sidebar upon receiving an application request for manipulation of the selected tile. The method includes determining a current status of the selected tile, selecting an appropriate tile manipulation rule for the application based on the current status of the tile, and manipulating the tile in accordance with the selected tile manipulation rule.

In yet a further aspect, the invention is directed to a method for controlling a selected tile within a sidebar based on user preferences. The method includes removing the selected tile from the sidebar upon receiving a user request for removal and refusing any subsequent request from an application to insert the selected tile into the sidebar. The method additionally includes granting any subsequent request from the user to insert the selected tile into the sidebar.

In an additional aspect of the invention, a method provides a user with control of the positioning of a selected tile within a sidebar based on user manipulation rules and application manipulation rules. The method includes inserting the selected tile in a preferred sidebar position in response to a user request to insert the selected tile and inserting the selected tile in less preferred sidebar position in response to an application request to insert the selected tile. The method additionally includes allowing a user to preemptively prevent an application from inserting the selected tile in the sidebar.

### BRIEF DESCRIPTION OF THE SEVERAL VIEWS OF THE DRAWING

The present invention is described in detail below with reference to the attached drawings figures, wherein:

FIG. 1 is an exemplary computing environment in which the present invention may be practiced;

FIG. 2 is a block diagram illustrating specific components of a system in accordance with an embodiment of the invention;

FIG. 3 is a screen shot illustration of a sidebar for practicing the present invention;

FIG. 4A is a screen shot showing a sidebar prior to the appearance of a transient tile;

FIG. 4B is a screen shot showing the sidebar of FIG. 4A including a transient tile;

FIG. 4C illustrates the sidebar of FIG. 4B after the transient tile has been removed and placed in an overflow area;

FIG. 5 is a block diagram illustrating a tile manipulation module in accordance with an embodiment of the invention;

FIG. 6 is a flow chart illustrating tile insertion procedures for a user and an application in accordance with an embodiment of the invention;

FIG. 7 is a flow chart illustrating tile removal procedures for a user and an application in accordance with an embodiment of the invention;

FIG. 8 is a state diagram showing relationships between tile states and user and application actions in accordance with an embodiment of the invention;

FIGS. 9A and 9B illustrate exemplary screen displays in accordance with an embodiment of the invention to facilitate a user's request to add or remove tiles from the sidebar;

FIG. 10 illustrates a sidebar along with an exemplary menu of options that may be available to a user for customizing the sidebar; and

FIG. 11 illustrates an embodiment of a task bar as known in the art.

### DETAILED DESCRIPTION OF THE INVENTION

Overview

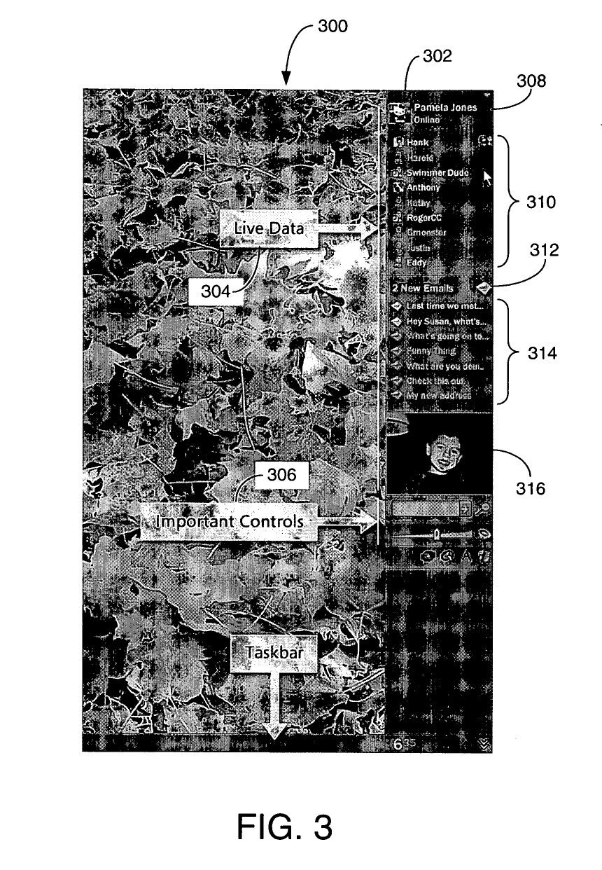

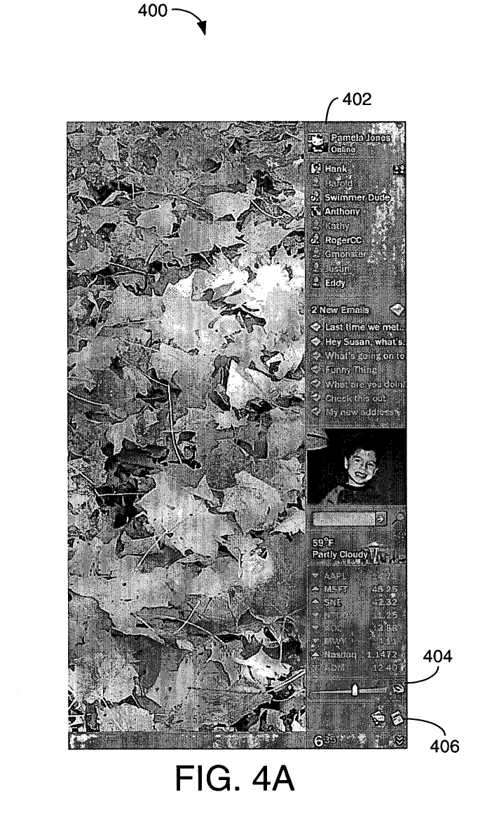

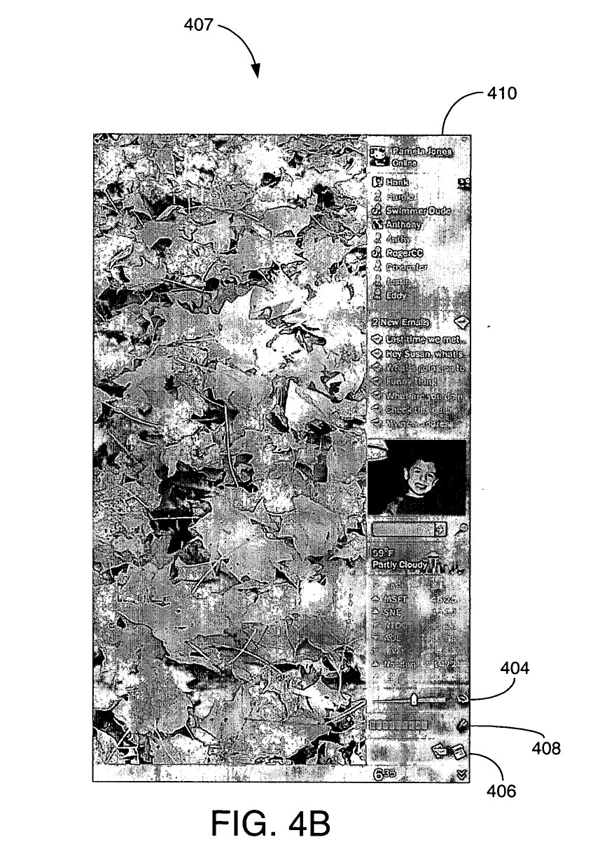

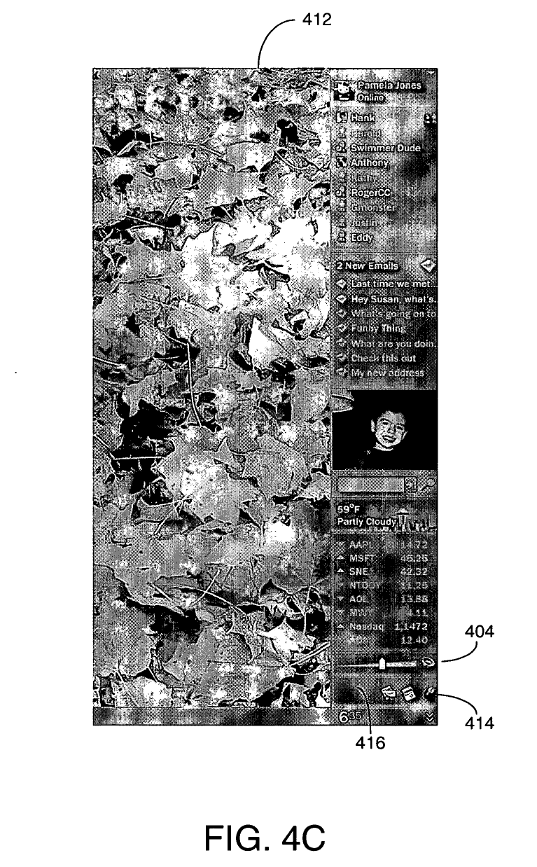

Embodiments of the present invention are directed to a system and method for controlling manipulation of tiles within a sidebar. The sidebar, as will be described below with relation to FIGS. 3 and 4 allows for application or user directed addition or removal of tiles in accordance with rules and conditions as set forth below.

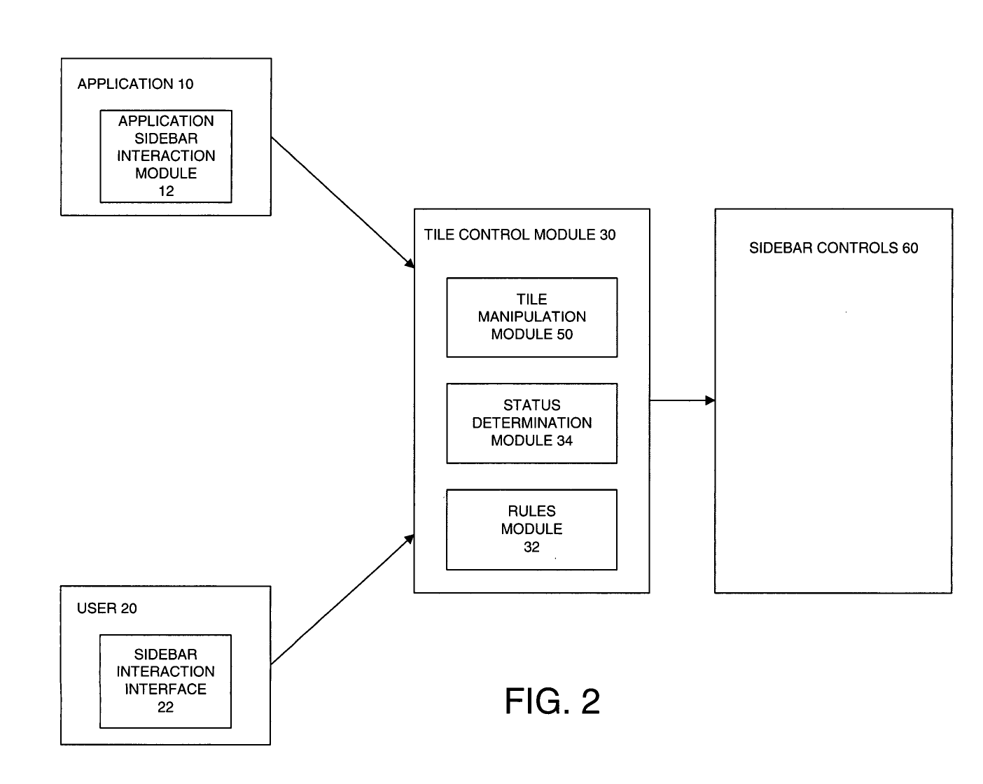

FIG. 2 is a block diagram illustrating a system in accordance with an embodiment of the invention. An application 10 and a user 20 requesting tile manipulation send requests through a tile control module 30 that interacts with sidebar controls 60. The application 10 may include an application/sidebar interaction module 12 that provides the application with the options for interacting with the sidebar. The user 20 is presented with a sidebar interaction interface 22 that offers the user multiple selectable options for manipulating a tile with the sidebar. Although FIG. 2 shows only one application 10, this representation is merely for simplicity, as any number of applications 10 may be present within the system.

The tile control module 30 receives requests for tile manipulation from both the application 10 and user 20. The tile control module 30 may include a tile manipulation module 50, a status determination module 34, and a rules module 32. Depending on the current status of the tile as determined by the status determination module 34 and the rules set for the application 10 or for the user 12 in the rules module 30, the tile manipulation module 50 will manipulate the tile as appropriate. As will be further explained below, the rules allow the user 20 greater discretion than the application 10 in determining which tiles should appear in the sidebar.

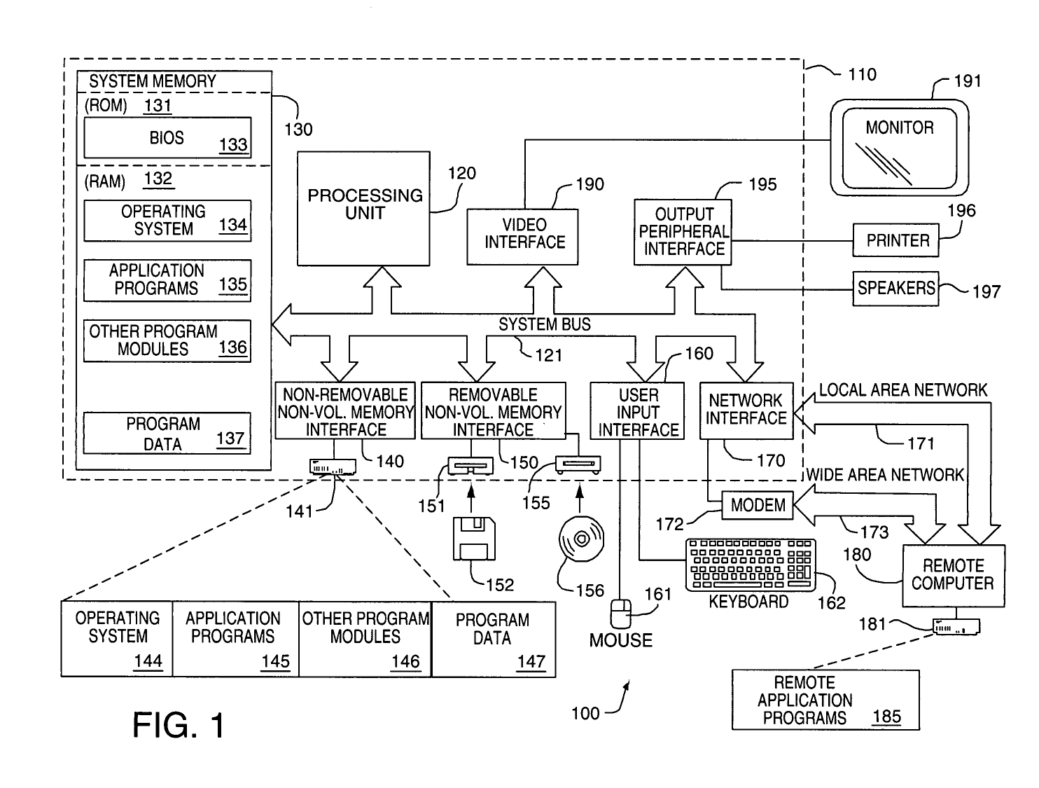

Having briefly provided an overview of the present invention, embodiments of the invention will be discussed with reference to FIGS. 1-10. An exemplary operating environment for the present invention is described below.

Exemplary Operating Environment

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

User Interface Sidebar

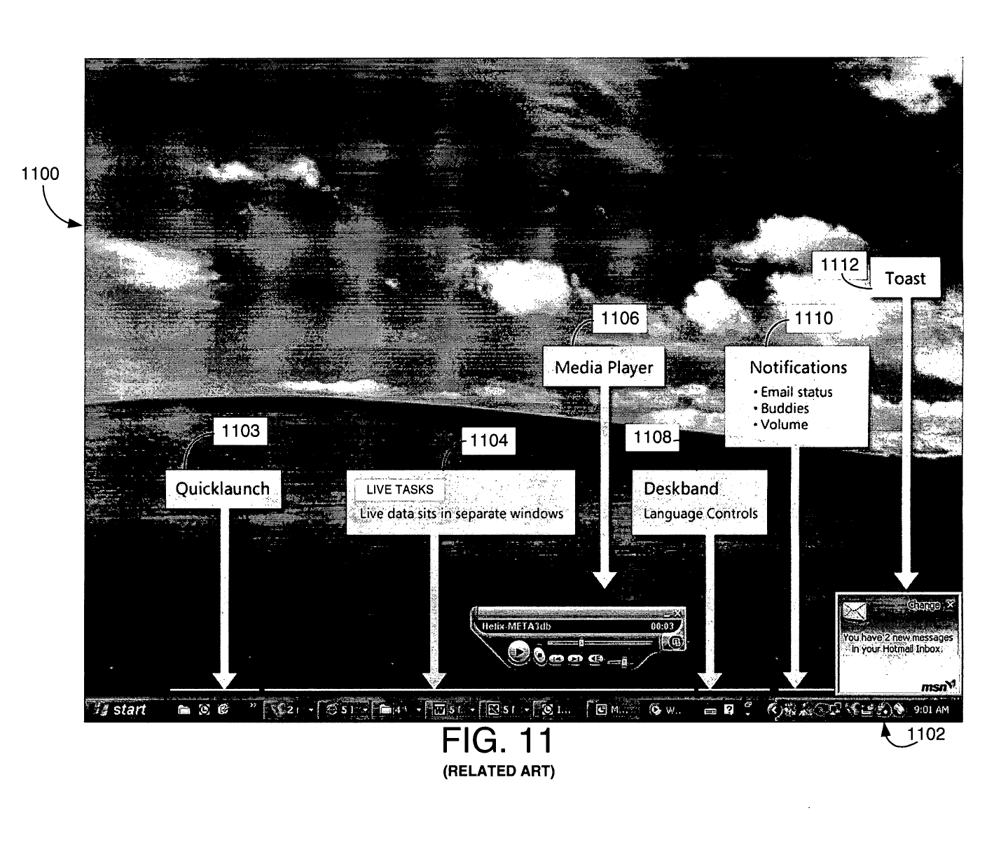

A sidebar, as illustrated in FIG. 3 can be contrasted with the conventional task bar as illustrated in FIG. 11. As used herein, a sidebar refers to a persistent display strip along one or more edges of a conventional display device such as the monitor 191 described in relation to FIG. 1 above. The sidebar includes tiles or dynamic thumbnails including a combination of a description of information of interest and a “viewer” for displaying whatever information is represented. A more detailed description of the sidebar and the tile, which is otherwise referred to as a ticket, can be found in the application for letters patent, Ser. No. 10/063,296, filed Jun. 8, 2001 which is hereby incorporated by reference. Various features of the sidebar are described in U.S. patent application Ser. No. 10/423,597, filed on Apr. 25, 2003, which is also hereby incorporated by reference.

As previously mentioned, conventional user interface displays restrict information that they present to a user. Such systems typically provide a task bar from which a user is able to activate an application window of interest in order to interact or obtain information. Various control types are utilized by such conventional prior art systems to present information to a user. Some of these control types include scroll bars, expandable short lists, start menus, dashboards, and controls that cause only active items to be visible. An example of a conventional user interface is illustrated in FIG. 11 and generally referenced as a display 1100.

As shown in FIG. 11, display 1100 includes a taskbar 1102. Generally, taskbar 1102 may contain a variety of task groupings or sections that provide access to applications or features of the operating environment through icons. For example, a section of taskbar 1102 may provide a quick-launch section 1103. Quick-Launch section 1103 enables the launching of one or more application programs such as a word processing application program, electronic mail program, or any other programs on the computing system that may have been appropriately configured to start from quick launch section 1103.

Another section of taskbar 1102, such as live-tasks 1104, may list currently executing tasks. From live-tasks 1104, a user may access a display window that is associated with a program in order to interact with program specific live data. An example of such a window is the media-player 1106 window. Using the media-player 1106 window, a user can view live information regarding the currently playing media and direct the actions of the media player at the user's discretion.

Yet another section of taskbar 1102 may be a desk-band 1108. Desk-band 1108 is an example of language controls for the operating environment.

A section of taskbar 1102 may also contain notifications 110. Notification area 1110 provides icons relating to application programs or system level communications. For example, electronic mail status, chat group buddies or even volume control can be accessed through icons in the notifications section 1110.

In an attempt to provide live status information, taskbar 1102 provides for a toast 1112. Toast 1112 is essentially a pop-up window that provides communication from an application program. For example, as shown a pop-up message is displayed informing the user that there are messages in an inbox.

When a significant amount of information is available, taskbar 1102 can become quite cluttered. Furthermore, the various types of icons available to an end user are inconsistent. Even further, taskbar 1102 does not easily provide a user with information and controls that the user may need to immediately access. Further still, taskbar 1102 involves a multiple step approach to access any information. For example, to get access to a volume control, a user must first select the volume control icon from the notifications section 1110. This causes a volume control to be displayed. The user can then adjust the volume to the desired level.

A user interface displaying a sidebar for use with an embodiment of the invention is shown in FIG. 3. Shown in display 300 is a sidebar 302. Sidebar 302 may include a live-data area 304, for live information of interest to the user, as well as a platform important-controls area 306, for frequently used controls. Within live-data 304, there may be a plurality of tiles related to a plurality of applications and information items. Important-controls 306 may also contain tiles for any one or more items used in controlling system or application parameters.

Live-data 304 contains for example, a ‘Pamela Jones Online’ tile 308, which may provide access to Internet or network applications, or other functions including messaging, chat, email and browsing. ‘Pamela Jones Online’ tile 308 further contains individual contact tiles 310. Some of the individual contact tiles 310, for ‘Pamela Jones Online’ 308 are also displayed within live-data 304. In other words, ‘Pamela Jones Online’ tile 308 may be thought of as a header and the individual contact tiles 310 would be considered the body. Another example of live-data 304 is the email notification tile 312, which contains a listing of emails 314. As shown, email notification 312 indicates that there are two new mail messages. Correspondingly, the top two email listings 314 are highlighted to indicate that they are new and unread. Yet another example of live-data 304 is a video tile 316, which is updated in real time within the sidebar 302. Sidebar 302 can located in a variety of ways and can provide varying information.

A user has the ability to modify the sidebar 302. A user can add, remove, resize tiles or perform other manipulations of the displayed tiles as necessary. An application can also add tiles to the sidebar. When a tile is added to the sidebar by an application, the sidebar determines if the total display area to be occupied by all tiles, including the new tile will exceed the display area of the sidebar. If the tiles will all fit into the sidebar, then the new tile is added to the sidebar and displayed. On the other hand, if the new tile will not fit at its default size, then all the tiles are compressed or “squished”. Thus, both existing tiles and the new tile are scaled down in size within the sidebar. The new tile is shown in a preview state, which may not necessarily show the complete content of the tile. If the previewed tile has a natural size that is too large, the tile may be cut off in addition to being scaled down. At the conclusion of the preview, the new tile grows to its natural size and may remain in the sidebar. Alternatively, the system will create an icon for the tile to be place in an overflow area.

The system applies any one of a number of criteria to select which tiles and how many of them would need to be removed from the sidebar to enable the remaining tiles to be displayed at their default sizes. With the ‘excess’ tile(s) removed, the remaining tiles may be expanded to their default sizes.

The system and method of the present invention can handle a variety of tiles. Some tiles may be visibly present all of the time. A transient tile is a tile that only appears as needed or as requested. The operations of a transient tile are best explained by way of an example, as shown in display 400 of FIG. 4A. The last tile shown within the sidebar 402 is a volume control tile 404, below which there is an overflow area 406. When a transient progress bar tile 408 (FIG. 4B) is needed, the tile is added to the sidebar 402, causing the sidebar 402 to become compressed or squished to make room.

A squished or compressed sidebar 410 is shown in display 407. The squished-sidebar 410 has all of its constituent tiles scaled down from their previous sizes in sidebar 402 of FIG. 4A. This squished preview state may only be maintained for a brief duration. The sidebar returns to its un-compressed state after the preview period and the transient tile is placed in the overflow area unless a user intervenes. This effect is shown in FIG. 4C, where transient progress bar tile 408 is removed from the sidebar 412, and a new icon 414 representative of the transient tile is placed in the overflow area 416.

As evidenced by the aforementioned explanation, a taskbar and a sidebar are separate and distinct concepts. The taskbar stays focused on managing windows for applications that consume large amounts of space and are full-fledged applications and creates a one-to-one relationship between windows available and items in the taskbar. When a user shuts down a computer, all of the running applications in the taskbar close and will not be in the taskbar upon the next login. In contrast, within the sidebar, minimized full-fledged applications housed in the sidebar have functionality that is not available when these applications are minimized in the taskbar. Furthermore, the sidebar can contain information in addition to full-fledged applications. Furthermore, the information in the sidebar is customized. After a user shuts down the computer, the applications may remain in the sidebar upon the next login.

Tile Manipulation

As set forth above in the Overview, FIG. 2 is a block diagram illustrating a system in accordance with an embodiment of the invention. An application 10 and a user 20 requesting tile manipulation send requests through a tile control module 30 that interacts with sidebar controls 60. The application 10 may include an application/sidebar interaction module that provides the application with the options for interacting with the sidebar. The user 20 is presented with a sidebar interaction interface 22 that offers the user multiple selectable options for manipulating a tile with the sidebar.

The tile control module 30 receives requests for tile manipulation from both the application 10 and user 20. The tile control module 30 may include a tile manipulation module 50, a status determination module 34, and a rules module 32. Depending on the current status of the tile as determined by the status determination module 34 and the rules set for the application 10 or for the user 12 in the rules module 30, the tile manipulation module 50 will manipulate the tile as appropriate.

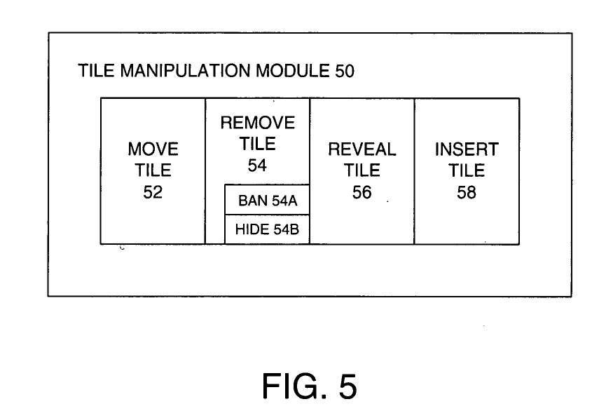

FIG. 5 illustrates additional details of the tile manipulation module 50. The tile manipulation module may include controls such as a move tile control 52 for relocating a tile within the sidebar and a remove tile control 54 for removing a tile from the sidebar. Tile removal control 54 can include both a control 54A for banning a tile and a control 54B for hiding a tile. These procedures will be further described below with reference to the method of the invention. A reveal tile control 56 may be used to reveal a hidden tile and an insert tile control 58 may be used to insert a tile in the sidebar.

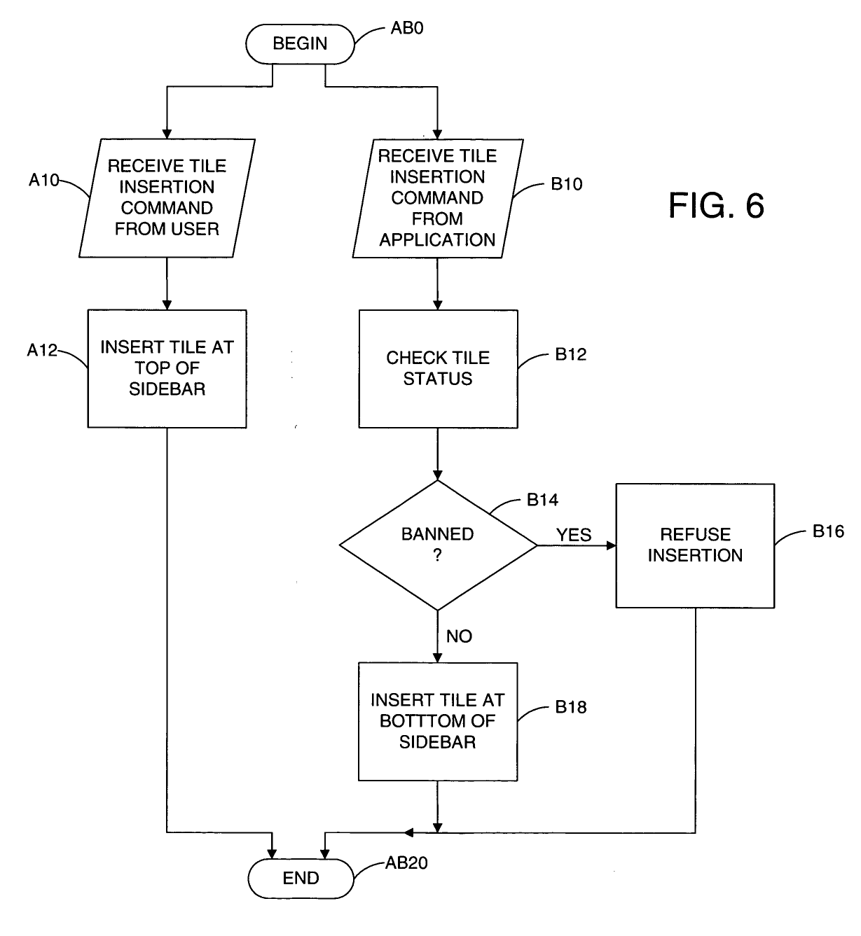

FIG. 6 is a flow chart illustrating the procedures for inserting a tile upon receipt of an insertion request from a user and upon receipt of an insertion request from an application. Tiles might be added to the sidebar in an automatic or user request mode. Automatic addition may occur in conjunction with the installation of application programs and with the operation of transient controls. User requested tile addition occurs through a tile configuration user interface program or by user designation within an application program. The mode of tile addition determines the priority and consequently the position of the tile within the sidebar.

The system receives a tile insertion command from a user in step A10. In step A12, the system inserts the requested tile, preferably at the top of the sidebar. If the request comes from an application in step B10, the system checks the tile status in step B12. If the tile has been banned by a user as determined in step B14, the system will refuse to insert the tile in step B16. If the tile has not been banned by the user in step B14, the system inserts the tile at the bottom of the sidebar in step B18. The process ends in step AB20.

Accordingly, as illustrated in FIG. 6, the rules module 32 is preferably set to allow a user discretion to insert a tile regardless of the state of the tile. However, when an application attempts to insert a tile, the rules in the rules module 32 are preferably configured to require determination that the tile has not been “banned” by the user as set forth in the state determination module 34. Thus, while a user can freely insert a tile, an application can only insert a tile that has not been rejected by a user.

With regard to positioning, when the user inserts a tile, the tile appears at the top of the sidebar, which is the most desirable position in the sidebar. If the application adds the tile unilaterally, the tile appears at the bottom of the sidebar, which is the least desirable position in the bar. The bottom of the sidebar is the least desirable position because it is the least visible and also because items at the bottom of the sidebar are the first to be placed in the overflow section. Furthermore, when the application inserts the tile, the user may be provided with an accompanying message asking if the user would like to remove the tile. This technique for controlling the insertion point for newly installed tiles and the confirmations used provide a primary technique for spam control within the sidebar.

As explained above with regard to FIGS. 4A-4C, when a new tile is added to the bar, the existing tiles compress or “squish” to make room for it. If the user added the tile, then it will appear at the top of the bar. After a few seconds, the tile at the bottom of the bar will move into the overflow. If an application added the tile, then the tile will appear at the bottom of the bar. In accordance with an embodiment of the invention, after a few seconds, the newly added tile will move into the overflow area.

As set forth above, tile addition may occur by user designation from within an application program. For instance, an application can host a standard control that adds a tile to the sidebar. When such a tile is added to the sidebar, the tile may be placed at the top of the bar as opposed to the other situations, where the tile is placed at the bottom of the bar. In those instances where there is insufficient room in the sidebar, the sidebar is squished as in all other cases. In this situation, prior to expansion, the system may flash the tiles at the bottom of the sidebar before bumping the flashing tiles into overflow.

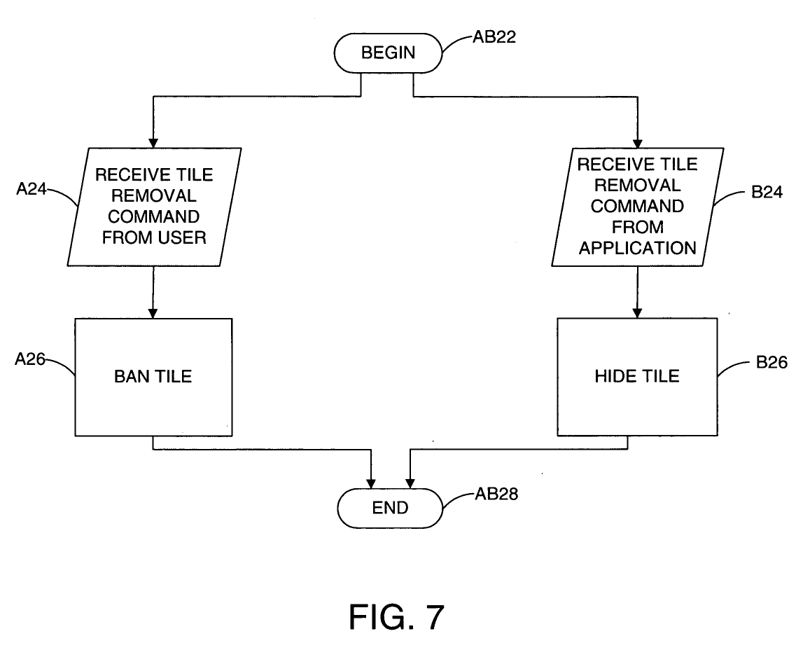

FIG. 7 is a flowchart illustrating removal of a tile in accordance with an embodiment of the invention. If the user requests removal of a tile in step A24, the system bans the tile in step A26. If a tile becomes banned by a user, an application will not be able to add the tile. Only users have the ability to ban tiles. If a tile removal command is received from an application in step B24, the system hides the tile in step B26. The hidden tile is not “banned” and can easily be re-inserted. The process ends in step AB28.

Table 1 below shows how a tile state and a requestor identity can effect the disposition of a selected tile.

TABLE 1

| | Representa- | Action if Requestor | Action if Requestor |
|---|---|---|---|
| Tile State | tion on UI | is User | is Application |
| Uninstalled | Not repre- | No action | Can install and check |
| | sented | | (visible) or can install |
| | | | and uncheck (hidden) |
| Visible | Checked | Can uncheck | Can uncheck |
| | | (becomes banned) | (becomes hidden) |
| Hidden | Grayed | Can uncheck | Can check (becomes |
| | | (becomes banned) | visible) |
| Newly | Unchecked | Can check (becomes | Can check (becomes |
| Installed | | visible) | visible) |
| Banned | Unchecked | Can check (becomes | No action |
| | | visible) | |

The sidebar has several different methods for allowing applications and users to add sidebar tiles. The net effect of these methods as described above is an environment where applications are able to take advantage of the sidebar but have incentive to leave the decision of what appears in the bar to the user.

With regard to applications, an application may install uninstalled tiles. Additionally, an application can add tiles to the sidebar as long as the tile hasn't been banned by the user. As shown in the first and fourth rows of Table 1, an application can install a tile and can check a newly installed tile to make the tile visible. As shown above in the last row of Table 1, applications have no actions available if a tile has been banned by the user. As stated above with regard to FIG. 6, if the application is able to add tiles, the newly added tiles appear at the bottom of the bar. Additionally, as shown in rows 2 and 3 of Table 1, applications can hide and show their own tiles from the bar once the tiles have been added. Applications check the installed tile to show it and uncheck the installed tile to hide it.

As shown in rows 1, 4, and 5 of Table 1, users can add newly installed or banned tiles to the sidebar. When a user adds a tile, it appears at the top of the bar. Users can also remove tiles from the sidebar. As shown in row 2 of Table 1, a user can remove a tile from the sidebar by unchecking a visible tile. When a user removes a tile, the tile becomes banned from the sidebar and an application cannot add the tile to the sidebar. Thus, the user has control over which tiles are allowed to appear in the bar and which are not.

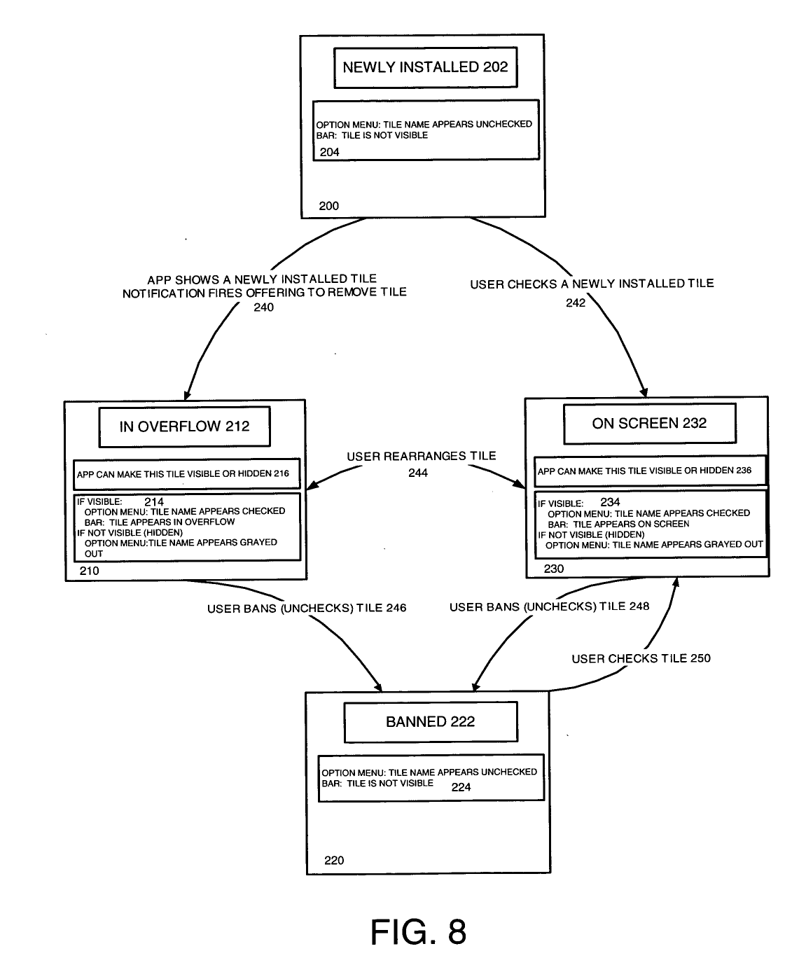

Several tile states are referenced in Table 1 and in FIG. 8 to be described below. “Installed” tiles are tiles that are currently existing tiles and “uninstalled” tiles are tiles for which the code has not yet been installed. Tiles having any of the designations that follow are also “installed” tiles. Reference to “allowed” tiles refer to tiles that have not been banned. By default, newly installed tiles are allowed in the bar. “Visible” tiles are tiles that are currently visible in the bar. A tile that is allowed in the bar has the ability to be invisible or visible in the bar. “On screen” refers to tiles that sit in the main portion of the sidebar. Space constraints limit the number of “on screen” tiles. Accordingly, “in overflow” refers to the tiles that are bumped to the overflow area due to space constraints.

The user interface for adding and removing tiles shows tiles in one of these states:

(1) Not there (not installed); (2) Checked (allowed and visible); (3) Grayed out (allowed and not visible); and (4) Unchecked (newly installed or banned).

In summary, a user can take the following actions: (1) check a newly installed or previously banned tile to put the tile at the top of the bar on screen; (2) uncheck a checked tile to ban the tile and remove it from the bar; (3) uncheck a grayed out tile to ban the tile and remove it from the bar; or (4) move a visible tile around in the sidebar.

In summary, an application can take the following actions: (1) show a newly installed tile at the end of the bar, perhaps in overflow, and fire a notification to the user (sidebar menu will show the tile as checked); (2) hide a tile by making a visible tile invisible (sidebar menu will show the tile as checked); or (3) show a hidden tile (sidebar menu will show the tile as checked). In this scenario (3), the tile appears in the same position as it was when it was hidden.

FIG. 8 is a state diagram illustrating tiles in several states and the actions that can be taken on these tiles by both the user and the application. Block 200 illustrates a newly installed tile 202 installed by an application. As indicated in information block 204, the option menu on the user interface will show the newly installed tile 202 as unchecked and the tile is not visible in the sidebar. When the application adds this tile as illustrated by arrow 240, a notification is fired to the user offering to remove the tile. Alternatively, the user may check the newly installed tile as indicated by arrow 242. As indicated in block 230, the checked tile will appear on screen in block 232.

The tile that is visible on screen at 232 can be acted upon by the application to hide the tile as indicated in block 236. As indicated in block 234, if the tile remains visible, the option menu will show the tile name as checked and the tile will appear in the sidebar. If the application chooses to hide the tile, the tile will be hidden and the name of the tile will be grayed out in the option menu.

A user can ban the visible on screen tile 232 by un-checking it as indicated by the arrow 248. The unchecked tile is represented by block 220 as a banned tile 222. As indicated by block 224, the option menu will show the tile name of the banned tile 222 as unchecked and the banned tile 222 will not be visible in the sidebar. After a tile is banned, only the user can restore the tile to the sidebar by re-checking the tile as indicated by arrow 250.

Returning to the newly added tile 202, if the user does not check the tile as illustrated by arrow 242, and instead the tile is added to the sidebar by the application and there is not enough room on the sidebar to accommodate the new tile, the tile will be placed in overflow as indicated by block 210 and become an overflow tile 212. The application can make this overflow tile visible or hidden as indicated at 216. If the overflow tile is visible, the tile appears checked in the options menu and appears in the overflow section of the sidebar as indicated at 214. If the tile is hidden, the tile name appears grayed out in the options menu and the tile itself does not appear on screen. As shown by arrow 244, a user may move a tile between overflow and a main portion of the sidebar.

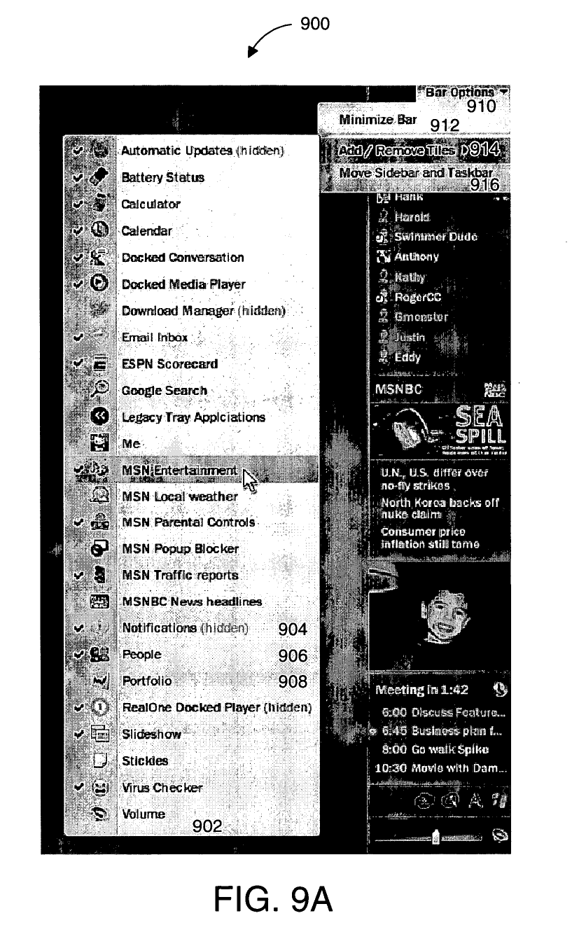

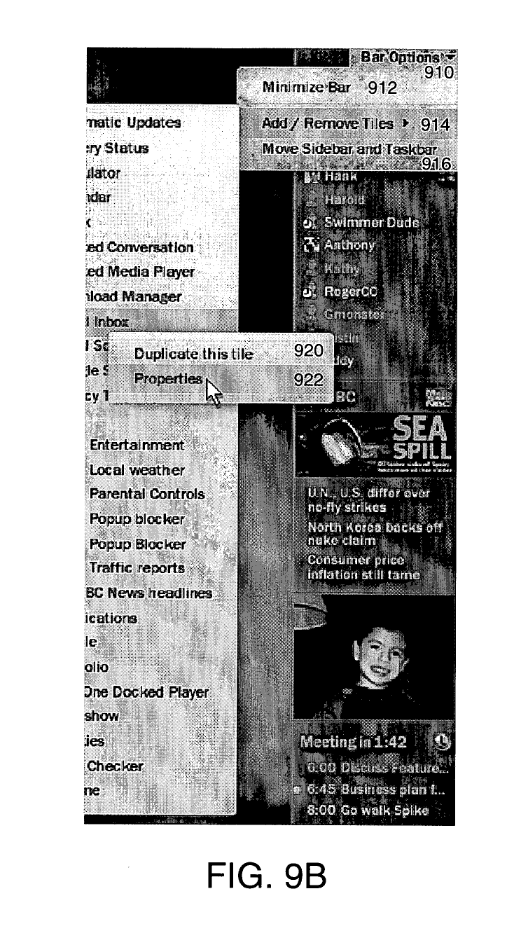

FIGS. 9A and 9B illustrate representations on the user interface during addition and removal of tiles. An options menu 902 shows each tile and its corresponding status. For example “notifications” 904 is checked, grayed, and hidden. Accordingly, this tile does not currently appear in the sidebar. A “people” tile 906 is checked and is not hidden. Therefore the “people” tile currently appears in the sidebar. A “portfolio” tile 908 is not checked and therefore does not appear in the sidebar. Since the “portfolio” tile 908 is not hidden, it has either been banned by the user or the tile is new and has never been added to the bar. A bar options window 910 shows the actions that can be taken by a user with respect to any given tile. The user may select a minimize bar command 913, an add or remove tiles command 914, or a move sidebar and taskbar command 916.

In a preferred embodiment, if a user selects a tile from the options menu 902, the tile will be added to the sidebar. If the user unchecks a tile from the options menu 902, the tile will be removed from the sidebar.

FIG. 9B illustrates a context menu that will appear if a user right clicks on a tile from the options menu 902. The context menu includes a duplication option 920 and a properties option 922. The duplicate tile option 920 may add another instance of the tile. The properties option 922 may appear for tiles that have a properties page.

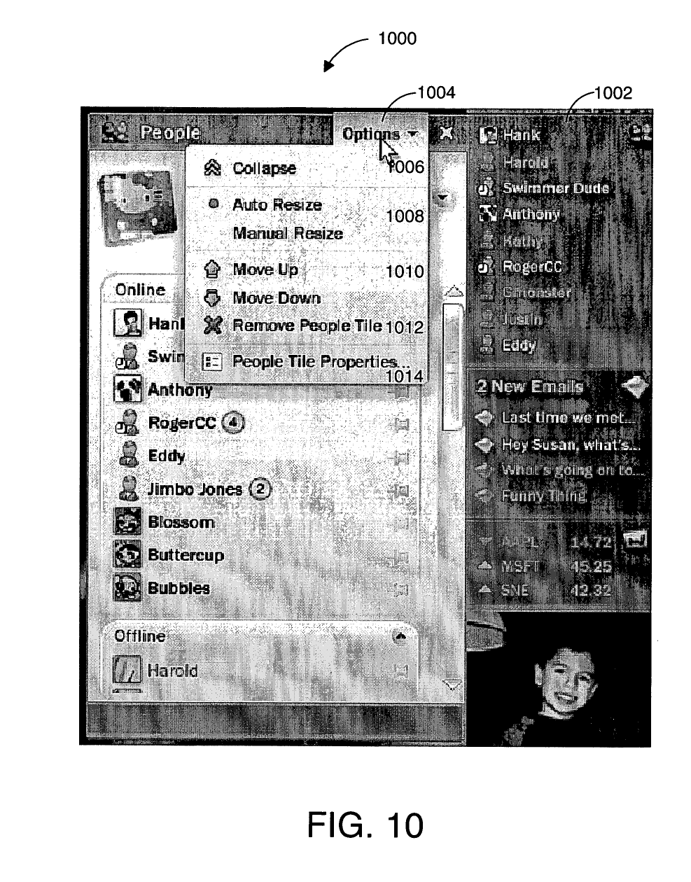

FIG. 10 illustrates a tile options menu 1004 available to the user. The tile options menu 1004 is adjacent the sidebar 1002 on the display 1000. The tile options menu 1004 includes a collapse option 1006, auto resize and manual resize options 1008, up and down movement options 1010, a remove tile option 1012, and a people tile properties option 1014. In general, these options provide for manipulation of tiles within the sidebar.

As set forth above, the disclosed system and method allow software applications to add tiles to a sidebar user interface and provide techniques for automatic and user management of tiles. An application may add tiles to the sidebar as long as the selected tiles have not been previously banned by the user. Such tiles appear at the bottom of the bar. Applications can choose to hide and show their own tiles from the bar once the tiles have been added. Users may also add tiles to the sidebar. When a user adds a tile, it appears at the top of the bar. Users may also remove tiles from the sidebar. When a user removes a tile, it is banned from the bar and an application cannot show the tile again without further user intervention.

In a preferred embodiment of the present invention, sidebars as well as tiles are created by utilizing application program interface (API) routines provided by the vendor of the operating system or other third parties. In the described examples of the preferred embodiment, the operating system environment is Microsoft Windows. As would be understood by those skilled in the art, the system and method of the present invention could be implemented within other tools and other operating environments without departing from the scope contemplated herein. Examples of tools in which the present invention can be practiced include Direct X and Macromedia.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A method for controlling tiles within a sidebar to respond to a manipulation request by a system user or by an application to manipulate a selected tile, the method comprising:
determining a current status of the selected tile;
selecting an appropriate rule set based on the identity of the manipulation requestor, wherein the appropriate rule set is one of an application manipulation rule set and a user manipulation rule set; and
locating an appropriate rule within the appropriate rule set based on the current status of the selected tile and content of the request.

2. The method of claim 1, further comprising manipulating the selected tile in accordance the appropriate rule.

3. The method of claim 2, further comprising receiving a request from the system user to add the selected tile to the sidebar and manipulating the tile to add the tile to a top of the sidebar.

4. The method of claim 2, further comprising receiving a request from the application to add the selected tile to the sidebar and manipulating the tile to add the tile to a bottom portion of the sidebar.

5. The method of claim 4, further comprising providing a user notification to instruct the system user regarding removal of the selected tile.

6. The method of claim 2, further comprising receiving an application request to show the selected tile, determining the status as hidden, and manipulating the selected tile to reveal the selected tile.

7. The method of claim 2, further comprising receiving an application request to hide the selected tile, determining the status as visible, and manipulating the selected tile to hide the selected tile.

8. The method of claim 2, further comprising receiving a user request to remove the selected tile and manipulating the tile by banning the tile from the sidebar.

9. The method of claim 1, further comprising receiving an application request to show the selected tile, determining the current status as banned, and refusing to show the tile based on the appropriate rule.

10. The method of claim 1, further comprising providing a user interface option menu for revealing the current tile status to the system user.

11. The method of claim 10, further comprising providing a check mark to indicate a visible tile.

12. The method of claim 10, further comprising providing a blank space to indicate one of a newly installed and a banned tile.

13. A system for controlling tiles within a sidebar when a manipulation request is made by a system user or by an application to manipulate a selected tile, the system comprising:
a status determination module for indicating a current status of the selected tile;
user manipulation rules for determining appropriate disposition of the selected tile based on the current status of the selected tile when the manipulation request originates from the system user;
application manipulation rules for determining disposition of the selected tile based on the current status of the selected tile when the manipulation request originates from the application; and
manipulation tools for manipulating the selected tile in accordance with one of the user manipulation rules and the application manipulation rules.

14. The system of claim 13, wherein the user manipulation rules provide for adding the selected tile to a top portion of the sidebar upon receiving a user request.

15. The system of claim 13, wherein the application manipulation rules provide for adding the selected tile to a bottom portion of the sidebar upon receiving an application request.

16. The system of claim 15, wherein the application manipulation rules further require providing a user notification to instruct the user regarding removal of the selected tile.

17. The system of claim 13, wherein the application manipulation rules provide for showing the selected tile upon receiving an application request after determining the current tile status as hidden.

18. The system of claim 13, wherein the application manipulation rules provide for hiding the selected tile upon receiving an application request and determining the current tile status as visible.

19. The system of claim 13, wherein the user manipulation rules provide for banning the selected tile from the sidebar upon receiving a user request.

20. The system of claim 13, wherein the application manipulation rules, upon determining the current tile status as banned, require refusal to show the selected tile upon receiving an application request.

21. The system of claim 13, further comprising a user interface option menu for revealing the current tile status to the system user.

22. The system of claim 21, wherein the user interface option menu comprises a status indicator including a check mark to indicate a visible tile.

23. The system of claim 21, wherein the user interface option menu includes a blank status indicator to indicate one of a newly installed and a banned tile.

24. A method for controlling a selected tile within a sidebar upon receiving an application request for manipulation of the selected tile, the method comprising:
determining a current status of the selected tile;
selecting an appropriate tile manipulation rule for the application based on the current status of the tile; and
manipulating the tile in accordance with the selected tile manipulation rule.

25. The method of claim 24, further comprising determining the current status as banned and selecting the appropriate tile manipulation rule that refuses entry of the selected tile in the sidebar.

26. The method of claim 24, further comprising determining the current status as hidden and selecting the appropriate tile manipulation rule that allows the application to reveal the hidden tile.

27. The method of claim 24, further comprising determining the current status as newly installed and selecting the appropriate tile manipulation rule that allows entry of the selected tile at a bottom portion of the sidebar.

28. The method of claim 27, further comprising providing a user notification allowing the user to remove the selected tile.

29. The method of claim 24, further comprising determining the current status as visible and selecting the appropriate tile manipulation rule that allows the application to render the tile hidden.

30. A method for controlling a selected tile within a sidebar based on user preferences, the method comprising:
removing the selected tile from the sidebar upon receiving a user request;
refusing any subsequent request from an application to insert the selected tile into the sidebar; and
granting any subsequent request from the user to insert the selected tile into the sidebar.

31. A computer-readable medium storing computer executable instructions for performing the method of claim 30.

32. A method for providing a user with control of the positioning of a selected tile within a sidebar based on user manipulation rules and application manipulation rules, the method comprising:
inserting the selected tile in a preferred sidebar position in response to a user request to insert the selected tile;
inserting the selected tile in less preferred sidebar position in response to an application request to insert the selected tile; and
allowing a user to preemptively prevent an application from inserting the selected tile in the sidebar.

33. A computer-readable medium storing computer executable instructions for the method of claim 32.
